(19) United States
(12) Patent Application Publication
(10) Pub. No.: US 2012/0086891 A1
(43) Pub. Date: Apr. 12, 2012

(54) LIQUID CRYSTAL DISPLAY DEVICE AND ELECTRONIC DEVICE USING THE SAME

(75) Inventors: Masahide INOUE, Chu-Nan (TW); Masahiro YOSHIGA, Chu-Nan (TW)

(73) Assignee: CHIMEI INNOLUX CORPORATION, Chu-Nan (TW)

(21) Appl. No.: 13/271,664

(22) Filed: Oct. 12, 2011

(30) Foreign Application Priority Data
Oct. 12, 2010 (JP) 2010-229463

(51) Int. Cl. G02F 1/1335

(52) U.S. Cl. 349/96

(57) ABSTRACT

A liquid crystal display device comprises a first substrate and a second substrate both of which have a first surface and a second surface, and a liquid crystal layer sandwiched between the first surface of the first substrate and the first surface of the second substrate. The liquid crystal display device further comprises a first polarizer and a second polarizer, which allows incident light incident to the second surface of the first substrate or the second surface of the second substrate to pass through the liquid crystal layer, and a photo sensor, formed on the first surface of the second substrate together with driver circuitry, sensing the light passing through the first polarizer and the second polarizer.

### CROSS REFERENCE TO RELATED APPLICATIONS

This Application claims priority of Japanese Patent Application No. 2010-229463, filed on October 12, 2010, the entirety of which is incorporated by reference herein.

### BACKGROUND OF THE INVENTION

1. Field of the Invention

The present invention relates to a liquid crystal display device and an electronic device using the same, wherein the liquid crystal display device comprises a first substrate and a second substrate, both of which have a first surface and a second surface; and a liquid crystal layer sandwiched by the first surface of the first substrate and the first surface of the second substrate, wherein circuitry for driving the liquid crystal layer is formed on the first surface of the second substrate.

2. Description of the Related Art

For a liquid crystal device, alignment of liquid crystals is usually appraised by a specialized appraisal device before final assembly of the product during the fabrication procedure (for example, Japanese published patent 1, No. 2003-156726). Since the alignment of liquid crystal is varied as lifetime, environment of the product or etc. varies, it is desirable that the state of the product can be understood from the appraisal.

Prior Art: Japanese published patent, No. 2003-156726

The purpose of the invention is to provide a liquid crystal display device and an electronic device using the same capable of appraising the alignment of the liquid crystal under the product state.

### BRIEF SUMMARY OF THE INVENTION

A detailed description is given in the following embodiments with reference to the accompanying drawings.

To achieve the objectives of the invention, a liquid crystal display in accordance with an embodiment of the invention includes a first substrate and a second substrate, both of which have a first surface and a second surface. A liquid crystal layer is sandwiched between the first substrate and the second substrate, wherein the first surface of the first substrate and the first surface of the second substrate face to each other. A circuitry for driving the liquid crystal layer is formed on the first surface of the second substrate, a first polarizer and a second polarizer, which allows incident light incident to the second surface of the first substrate or the second surface of the second substrate to pass through the liquid crystal layer. A photo sensor is formed together with the circuitry on the first surface of the second substrate, detecting the light passing through the first polarizer and the second polarizer.

Therefore, a liquid crystal display device capable of appraising the alignment of the liquid crystals under the product state is provided.

In an embodiment, the first polarizer is disposed on the second surface of the first substrate, and the second polarizer is disposed on the second surface of the second substrate. The liquid crystal display device further comprises a reflector disposed on the first polarizer, wherein the photo sensor detects light which is incident to the second surface of the second substrate, wherein the light passes through the second polarizer, the liquid crystal layer, and the first polarizer in sequence and then is reflected by the reflector.

In an embodiment, the circuitry comprises a plurality of source lines applying signal voltages to the liquid crystal layer, and a common electrode, disposed on the first substrate, applying a reference voltage to the circuitry. The liquid crystal display device further comprises a voltage adjusting device responding to light intensity detected by the photo sensor and adjusting the voltages of the plurality of source lines or the reference voltage of the common electrode.

The voltage adjusting device includes a variable voltage source and a power control device controlling the variable voltage source according to the light intensity detected by the photo sensor.

In an embodiment, the liquid crystal display further includes a third polarizer partially disposed on a detection surface of the photo sensor, wherein the photo sensor detects light which is incident to the second surface of the first substrate. The light passes through the first polarizer, the liquid crystal layer, and the third polarizer in sequence and then reaches the detection surface of the photo sensor.

In an alternative embodiment, the first polarizer is disposed on the second surface of the first substrate, and the second polarizer is disposed on a detection surface of the photo sensor, and the photo sensor detects light which is incident to the second surface of the first substrate, wherein the light passes through the first polarizer, the liquid crystal layer, and the second polarizer in sequence and then reaches the detection surface of the photo sensor.

In the above embodiment, the liquid crystal display further includes a third polarizer partially disposed on the second surface of the second substrate and a reflector disposed on the first surface of the first substrate, wherein the photo sensor detects light which is incident to the second surface of the second substrate, wherein the light passes through the third polarizer, is reflected by the reflector, passes through the second polarizer in sequence, and then reaches the detection surface of the photo sensor.

In an embodiment, the liquid crystal display device of the invention can be applied to electronic devices with functions of providing users with images, such as a television, a cell phone, a PDA, a laptop or desktop computer, a car navigation device, a portable game device, an AURORA VISION, or etc.

According to the embodiments, a liquid crystal display device and an electronic device using the same capable of appraising the alignment of the liquid crystal under the product state are provided.

### BRIEF DESCRIPTION OF THE DRAWINGS

The present invention can be more fully understood by reading the subsequent detailed description and examples with references made to the accompanying drawings, wherein:

FIG. 1 is a cross section view of a liquid crystal display device in accordance with a first embodiment of the invention

FIG. 2 is a cross section view of a liquid crystal display device in accordance with a second embodiment of the invention.

FIG. 3 is a cross section view of a liquid crystal display device in accordance with a third embodiment of the invention.

FIG. 4 is a cross section view of a liquid crystal display device in accordance with a fourth embodiment of the invention.

FIG. 5 is a diagram showing a structure of the liquid crystal display device in accordance with an embodiment of the invention.

FIG. 6 is a diagram showing a circuit structure of a pixel in the liquid crystal display device in accordance with an embodiment of the invention.

FIG. 7 is a block diagram showing a structure of the common electrode driver in the liquid crystal display device in accordance with an embodiment of the invention.

FIG. 8 is an example showing an electronic device provided with the liquid crystal display device in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

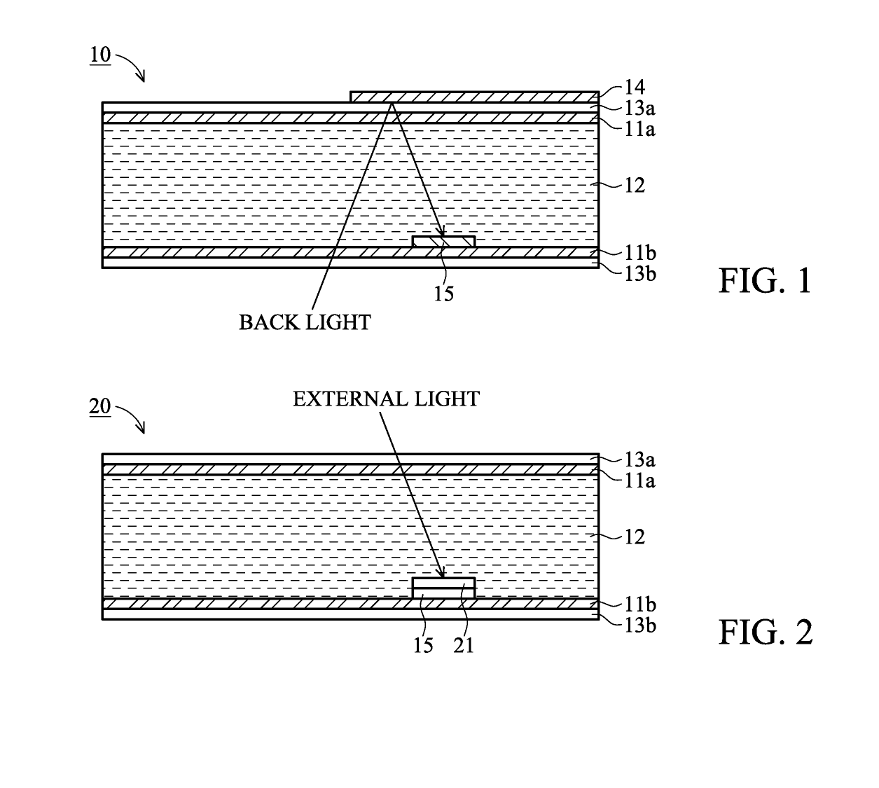

FIG. 1 is a cross section view of a liquid crystal display device in accordance with a first embodiment of the invention. In FIG. 1, the liquid crystal display device 10 comprises a first substrate 11a and a second substrate 11b, both of which have a first surface and a second surface. The first surfaces of the first substrate 11a and the second substrate 11b face each other and have a gap therebetween. Liquid crystals are injected into the gap between the first substrate 11a and the second substrate 11b, forming a liquid crystal layer 12. Circuitry for driving the liquid crystal layer 12 is formed on the first surface of the second substrate 11b. The circuitry is formed by active elements such as thin film transistors (TFT) and transparent electrodes such as Indium-tin-oxide (ITO) electrodes.

The liquid crystal display device 10 further comprises a first polarizer 13a disposed on the second surface of the first substrate 11a, a second polarizer 13b disposed on the second surface of the second substrate 11b, and a reflector 14 disposed on the first polarizer 13a. The reflector 14 reflects light from a back light source (not shown in FIG. 1), which is incident to the second surface of the second substrate 11b and passes through the second polarizer 13b, the liquid crystal layer 12, and the first polarizer 13a. The light reflected by the reflector 14 then travels back to the liquid crystal layer 12 and is detected by a photo sensor 15 formed on the first surface of the second substrate 11b.

FIG. 2 is a cross section view of a liquid crystal display device in accordance with a second embodiment of the invention. The liquid crystal display device 20 is not provided with the reflector 14 and a polarizer component 21 is disposed on the detection surface of the photo sensor 15. Other than the above differences, the other structures of the liquid crystal display device 20 are identical to that of the liquid crystal display device 10. The polarizer component 21 has properties identical to that of the first polarizer 13a and the second polarizer 13b, ideally.

In the liquid crystal display device 20, the photo sensor 15 detects external light such as sunshine or a lamplight which is incident to the second surface of the first substrate 11a and passes through the first polarizer 13a, the liquid crystal layer 12, and the polarizer component 21.

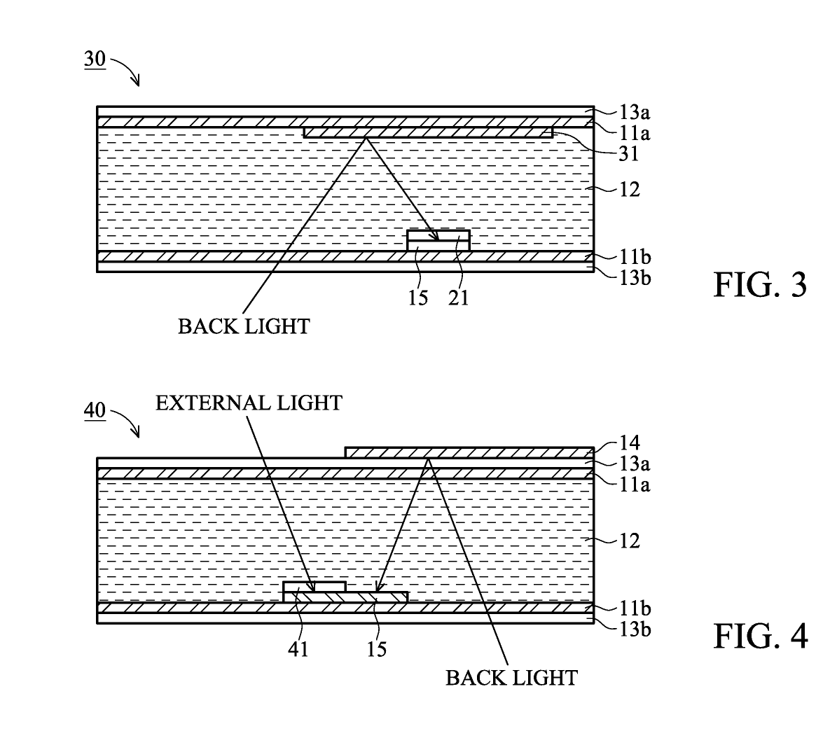

FIG. 3 is a cross section view of a liquid crystal display device in accordance with a third embodiment of the invention. The liquid crystal display device 30 is provided with a reflector 31 disposed on the first surface of the first substrate 11a. Other than the above difference, the other structures of the liquid crystal display device 30 are identical to that of the liquid crystal display device 20 shown in FIG. 2.

In the liquid crystal display device 30, the photo sensor 15 detects light from a back light source (not shown in FIG. 3), which is incident to the second surface of the second substrate 11b and passes through the second polarizer 13b, and then is reflected by the reflector 31 in the liquid crystal layer 12 and passes through the polarizer component 21.

Here, the thickness of the reflector 31 can be a half of the thickness of the liquid crystal 12. If the reflector 31, relative to the liquid crystal layer 12, is thin enough, the light to be detected by the photo sensor 15 will travel for two times the thickness of the liquid crystal layer 12 to reach the photo sensor 15, because the light is reflected by the reflector 31 once in the liquid crystal layer 12. In the case where the thickness of the reflector 31 is a half of the thickness of the liquid crystal layer 12, even though the light is reflected once, the distance that the light moves in the liquid crystal layer 12 would be substantially identical to the thickness of the liquid crystal 12.

Therefore, a reflector 31 with an appropriate thickness can be disposed to adjust the thickness of the liquid crystal layer 12. Because transmission rate of light in liquid crystals varies as the thickness of the liquid crystal layer varies, the detection accuracy of the photo sensor and the appraisal of the liquid crystal alignment will improved.

FIG. 4 is a cross section view of a liquid crystal display device in accordance with a fourth embodiment of the invention. The liquid crystal display device 40 shown in FIG. 4 combines the embodiments shown in FIG. 1 and FIG. 2, wherein a polarizer component 41 is disposed on a part of the detection surface of the photo sensor 15.

In the liquid crystal display device 40, the photo sensor 15 can detect light from a back light source (not shown in FIG. 4) which is incident to the second polarizer 13b and path through the second surface of the second substrate 11b, the liquid crystal layer 12, and the first polarizer 13a (namely, light reflected by the reflector 14) and external light such as sunshine or a lamplight which is incident to the first polarizer 13a and passes through the second surface of the first substrate 11a, the liquid crystal layer 12, and the polarizer component 41.

According to the embodiments shown in FIGS. 1-4, even though the liquid crystal device is assembled in a product, light from the back light source or the environment can still be detected after passing through a pair of polarizers sandwiching a liquid crystal layer. Therefore, the alignment of the liquid crystal can be appraised based on the amount of transmissive light at the time when the liquid crystal is applied with a signal voltage. In addition, the liquid crystal display device of the invention has an advantage over conventional liquid crystal display devices, in that manufacturing costs are lower because the photo sensor is formed together with the circuitry for driving the liquid crystal on a substrate.

The liquid crystal display device of the invention can compensate for photo leakage current based on the detection result from the photo sensor 15. The photo leakage current causes flicker, crosstalk, and/or smearing. Following is the description of a structure and operation of a liquid crystal display device of the invention used to compensate for the photo leakage current.

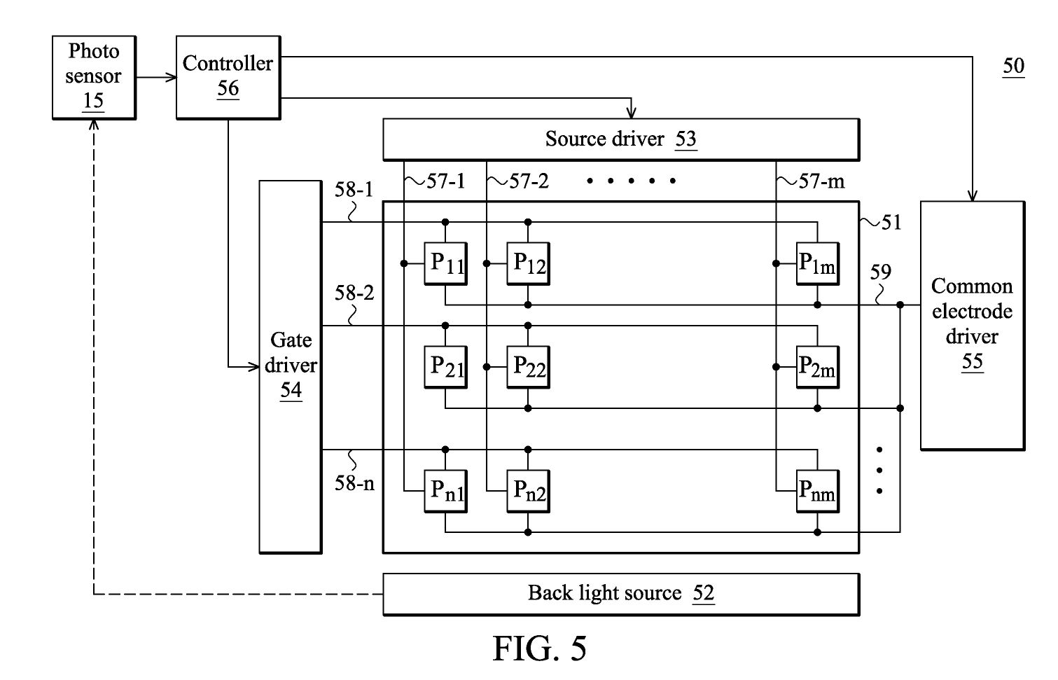

FIG. 5 is a diagram showing a structure of the liquid crystal display device in accordance with an embodiment of the invention. The liquid crystal display device 50 shown in FIG. 5 is an active matrix type liquid crystal display device. The liquid crystal display device 50 comprises a display panel 51 comprising a photo sensor 15, a back light source 52, a source driver 53, a gate driver 54, a common electrode driver 55, and a controller 56.

The display panel 51 comprises source lines 57-1˜57-m (m is an integer), gate lines 58-1˜58-n (n is an integer) orthogonal to the source lines 57-1˜57-m, and a plurality of pixels P₁₁˜Pₙₘ formed by dividing a liquid crystal layer (for example, the liquid crystal layer 12 in FIG. 1) into a matrix of rows and columns to be located at the cross sections of the source lines 57-1˜57-m and the gate lines 58-1˜58-n. The source lines 57-1˜57-m and the gate lines 58-1˜58-n are formed together with the circuitry for driving the liquid crystal on a substrate (for example, the first surface of the second substrate 11b in FIG. 1).

The back light source 52 is disposed on the back of the display panel 51 and shines light on the pixels P₁₁˜Pₙₘ. The display panel 51 changes the alignment of the liquid crystals by applying voltages thereto, so as to polarize the light illuminating from the back light source 52 to display images. To achieve the above operation, the source driver 53 applies signal voltages to the pixels P₁₁˜Pₙₘ via the source lines 57-1˜57-m and the gate driver 54 controls the timings of the application of the signal voltages of the pixels P₁₁˜Pₙₘ via the gate lines 58-1˜58-n. The liquid crystal display device of this embodiment takes a transmissive display device using a back light source disposed on the back of the display panel as an example, but other types of liquid crystal display devices can be applied in the invention, such as a reflective display device using external light rather than back light, or a transflective display device using both external light and back light.

The common electrode driver 55 applies reference signals to the pixels P₁₁˜Pₙₘ via a common electrode 59 which is commonly connected to all of the pixels P₁₁˜Pₙₘ. The common electrode 59 is formed on a substrate (for example, the first surface of the first substrate 11a in FIG. 1) opposite to the substrate on which the source lines 57-1˜57-m and the gate lines 58-1˜58-n are formed.

The controller 56 synchronizes the source driver 53, the gate driver 54, and the common electrode driver 55, and controls the devices. For example, after receiving the detection result from the photo sensor 15, the controller 56 controls the source driver 53 or the common electrode driver 55 to adjust the voltages on the source lines 57-1˜57-m or the voltage on the common electrode 59.

In addition, the photo sensor 15 can also be directly connected to the source driver 53 or the common electrode driver 55 without being connected to the controller 56. Although not shown in FIG. 5, an analog-digital converter, an integrator, a low-pass filter, or etc. can be disposed at the output of the photo sensor 15 to convert the form of the detection result from the photo sensor 15.

For example, the photo sensor 15 is the photo sensor shown in FIGS. 1,3, and 4, used to detect the light from the back light source 52.

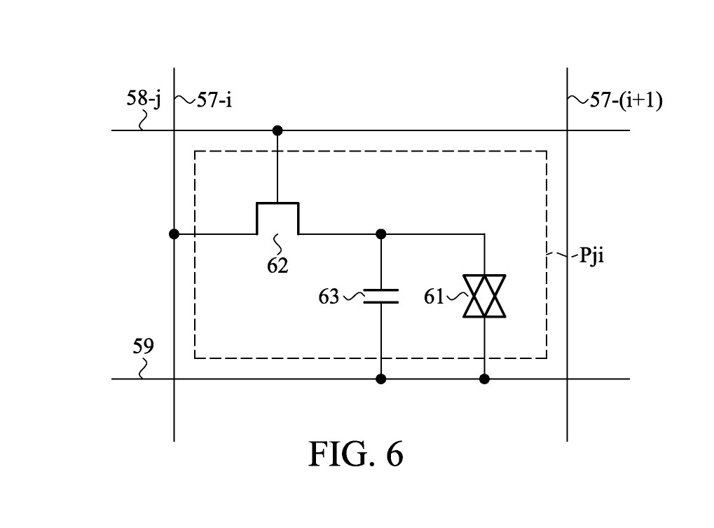

FIG. 6 is a diagram showing a circuit structure of a pixel in the liquid crystal display device in accordance with an embodiment of the invention. The pixel Pⱼᵢ, (i and j are integers, wherein 1≦i≦m and 1≦j≦n) comprises a liquid crystal cell 61, a switching device 62 controlling the application of the signal voltage to the liquid crystal cell 61, and a holding capacitor 63 holding the signal voltage applied to the liquid crystal cell 61 till a next scan starts.

One terminal of the liquid crystal cell 61 is connected to the common electrode 59 and the other one is connected to a source line 57-i via the switching device 62.

The switching device 62 can be a thin film transistor (TFT) and the control terminal of the switching device 62 is connected to the gate line 58-j. The switching device 62 is conducted when the potential of the gate line 58-j is High, so that the signal voltage on the source line 57-i can be applied to the liquid crystal cell 61.

The holding capacitor 63 is parallel connected with the liquid crystal cell 61, wherein one terminal of the holding capacitor 63 is connected to a node (usually called “a pixel electrode”) between the liquid crystal cell 61 and the switching device 62, and the other terminal is connected to the common electrode 59. When the potential of the gate line 58-j is Low, the switching device 62 is not conducted. During this period, namely a period in which pixel data is being rewritten, the holding capacitor 63 holds a signal voltage applied to the liquid crystal cell 62 in the form of electrical charges.

Actually, when external light or back light is illuminated onto the switching device 62, the electrical charges stored by the holding capacitor 63 may decrease because of leakage of current flowing to the source line 57-i via the switching device 62. The leakage current flow is usually called a photo leakage current. The photo leakage current makes the holding voltage of the holding capacitor 63 decrease, causing problems such as flicker, crosstalk, and/or smearing.

During the period in which the holding capacitor 63 holds the voltage, the common electrode driver 55 adjusts the voltage on the holding capacitor 63 via the common electrode 59 to compensate for the photo leakage current. Capacitive coupling of the holding capacitor 63 is used to shift the voltage at a terminal of the liquid crystal cell 61 which is connected to the source line 57-i via the switching device 62. Therefore, photo leakage current is compensated for.

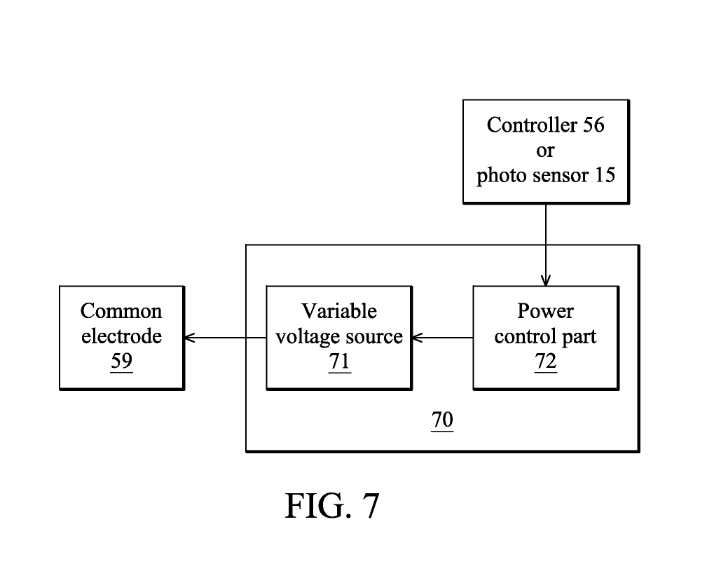

FIG. 7 is a block diagram showing a structure of the common electrode driver in the liquid crystal display device in accordance with an embodiment of the invention. The common electrode driver 55 comprises a voltage adjusting part 70 which is used to adjust voltages supplied to the pixels P₁₁˜Pₙₘ via the common electrode 59. The voltage adjusting part 70 is provided with a variable voltage source 71 and a power control part 72 controlling the variable voltage source 71. Based on the result produced by the controller 56 or the detection result transmitted directly from the photo sensor 15, the power control part 72 controls the variable voltage source 71 so as to supply a predetermined reference voltage.

For example, when photo leakage current occurs, the voltage of the pixel electrode will decrease, which causes liquid crystal alignments to vary. Such variation causes a variation of the light intensity detected by the photo sensor 15. Accordingly, in such a case, the power control part 72 raises the potential of the common electrode 59 which is opposite to the pixel electrode across the holding capacitor 63 by the amount by which the pixel electrode drops, so as to compensate for the voltage drop caused by the photo leakage current. Therefore the power control part 72 can use the relation formula between the light intensity detected by the photo sensor 15 and the amount of the photo leakage current of each pixel occurring during the voltage holding period or a table which stores the above relation in advance, to change the voltage supplied by the variable voltage source 71.

As an alternative embodiment, the voltage adjusting part can be incorporated in the source driver 53 rather than the common electrode driver 55. In this embodiment, during the voltage holding period of a pixel Pⱼᵢ, the photo leakage current can be compensated for by adjusting the voltage on the source line 57-i connected to the pixel Pⱼᵢ.

Therefore, the liquid crystal display device of the invention does not need to incorporate circuitry for compensating for the photo leakage current into a pixel, so that the aperture of the pixel can be maintained while the photo leakage current is compensated for. In prior art, methods such as increasing the capacitance of the holding capacitor or inserting an amplifier circuit between the holding capacitor and the liquid crystal cell are usually adopted to compensate for the photo leakage current. Therefore, a problem of small pixel apertures exists.

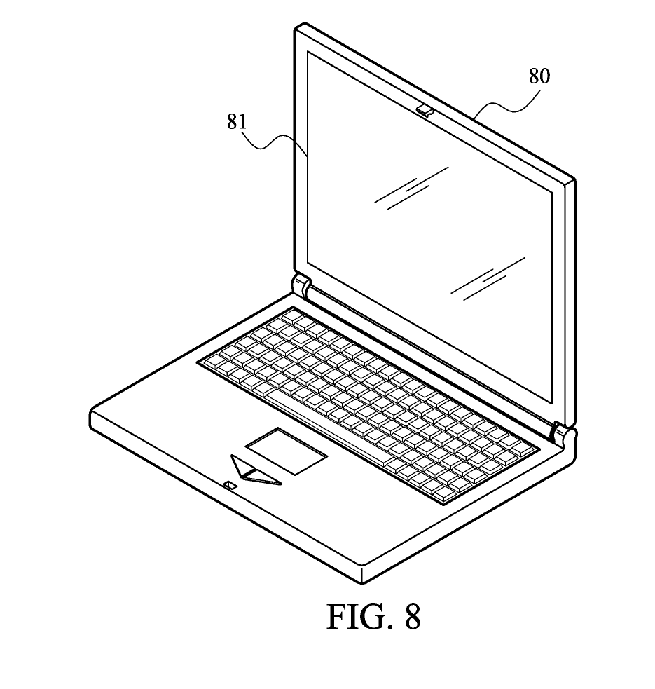

FIG. 8 is an example showing an electronic device provided with the liquid crystal display device in accordance with an embodiment of the invention. The electronic device 80 in FIG. 8 is represented by a laptop computer, but other electronic devices such as a television, a cell phone, a watch, a PDA, a desktop computer, a car navigation device, a portable game device, an AURORA VISION, or etc. is also suitable for the invention. The electronic device 80 is provided with the liquid crystal display device 81 having a display panel to show images.

The liquid crystal display device 81 can be any one of the liquid crystal display devices shown in FIG. 1-7, which is provided with a photo sensor capable of detecting light which is illuminated by a back light source and/or an external light source and passes through two polarizers sandwiching the liquid crystal layer. Therefore, the electronic device 80 can appraise the alignment of the liquid crystal of the liquid crystal display device under the product state.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art).

For example, in the embodiments shown in FIGS. 1-4, a light guide used to limit the light path can be installed into the liquid crystal display device so that light which is illuminated by the back light source and/or the external light source can pass through two polarizers sandwiching the liquid crystal layer and reach the photo sensor 15.

What is claimed is:

1. A liquid crystal display device, comprising:
a first substrate and a second substrate, both of which have a first surface and a second surface;
a liquid crystal layer sandwiched between the first substrate and the second substrate, wherein the first surface of the first substrate and the first surface of the second substrate face to each other, and a circuitry for driving the liquid crystal layer is formed on the first surface of the second substrate;
a first polarizer and a second polarizer, which allows incident light incident to the second surface of the first substrate or the second surface of the second substrate to pass through the liquid crystal layer; and
a photo sensor formed together with the circuitry on the first surface of the second substrate, detecting the light passing through the first polarizer and the second polarizer.

2. The liquid crystal display device as claimed in claim 1, wherein the first polarizer is disposed on the second surface of the first substrate, and the second polarizer is disposed on the second surface of the second substrate, and the liquid crystal display device further comprises a reflector disposed on the first polarizer, wherein the photo sensor detects light which is incident to the second surface of the second substrate, wherein the light passes through the second polarizer, the liquid crystal layer, and the first polarizer in sequence and then is reflected by the reflector.

3. The liquid crystal display device as claimed in claim 1, wherein the circuitry comprises a plurality of source lines applying signal voltages to the liquid crystal layer, and a common electrode, disposed on the first substrate, applying a reference voltage to the circuitry, and the liquid crystal display device further comprises a voltage adjusting device responding to light intensity detected by the photo sensor and adjusting the voltages of the plurality of source lines or the reference voltage of the common electrode.

4. The liquid crystal display device as claimed in claim 3, wherein the voltage adjusting device comprises:
a variable voltage source; and
a power control device controlling the variable voltage source according to the light intensity detected by the photo sensor.

5. The liquid crystal display device as claimed in claim 1, further comprising:
a third polarizer partially disposed on a detection surface of the photo sensor,
wherein the photo sensor detects light which is incident to the second surface of the first substrate, wherein the light passes through the first polarizer, the liquid crystal layer, and the third polarizer in sequence and then reaches the detection surface of the photo sensor.

6. The liquid crystal display device as claimed in claim 1, wherein the first polarizer is disposed on the second surface of the first substrate, and the second polarizer is disposed on a detection surface of the photo sensor, and the photo sensor detects light which is incident to the second surface of the first substrate, wherein the light passes through the first polarizer, the liquid crystal layer, and the second polarizer in sequence and then reaches the detection surface of the photo sensor.

7. The liquid crystal display device as claimed in claim 6, further comprising:
a third polarizer partially disposed on the second surface of the second substrate; and
a reflector disposed on the first surface of the first substrate,
wherein the photo sensor detects light which is incident to the second surface of the second substrate, wherein the light passes through the third polarizer, is reflected by the reflector, passes through the second polarizer in sequence, and then reaches the detection surface of the photo sensor.

8. An electronic device, comprising the liquid crystal display device as claimed in claim 1.
